(19) United States
(12) Patent Application Publication
(10) Pub. No.: US 2010/0161498 A1
(43) Pub. Date: Jun. 24, 2010

(54) METHOD, SYSTEM AND COMPUTER PROGRAM PRODUCT FOR CREATING A REAL ESTATE PRICING INDICATOR AND PREDICTING REAL ESTATE TRENDS

(75) Inventors: Robert WALKER, Tustin, CA (US); Benjamin GRABOSKE, Coto de Caza, CA (US)

Correspondence Address: OBLON, SPIVAK, MCCLELLAND MAIER & NEUSTADT, L.L.P., 1940 DUKE STREET, ALEXANDRIA, VA, 22314, US

(73) Assignee: First American CoreLogic, Inc., Santa Ana, CA (US)

(21) Appl. No.: 12/637,448

(22) Filed: Dec. 14, 2009

Related U.S. Application Data
(60) Provisional application No. 61/122,236, filed on Dec. 12, 2008.

(51) Int. Cl. G06Q 50/00

(52) U.S. Cl. 705/306

(57) ABSTRACT

A real estate market trend apparatus, computer program product and method obtains property data for each available property within a geographic area; sends the data to an AVM to calculate the valuation for each real property within the geographic area; saves the estimated valuations in memory; develops a time-consistent set of valuations for each property; provides a valuation for each of the available properties within the geographic area; and computes an indicator which provides a trend analysis of the real estate property market for the geographic area.

### CROSS REFERENCE TO RELATED APPLICATIONS

This application is based upon and claims the benefit of priority of U.S. Provisional Patent Application Ser. No. 61/122,236, filed Dec. 12, 2008, the entire contents of which is incorporated herein by reference.

### BACKGROUND OF INVENTION

a. Field of Invention

The invention relates generally to a method, system and computer program product for predicting real estate trends, and more particularly, to a method and system for creating a real estate pricing indicator. More specifically, the present invention provides a nationwide database of real estate properties, which are being valued on a desired time intervals to create an up-to-date database, which is then transformed into real estate pricing indicators used to predict real estate trends.

b. Description of Related Art

There are several different methods used in determining median value of homes. The first method is the median value technique. The median value represents a “central tendency” in a population. This is because 50% of the observations occur above the median and 50% occur below the median. Measuring the change in median sales value has achieved increased adoption over the past several years. The method involves collecting sales transactions for residential homes in a geographical area and calculating the median sale price for only those home sale transactions that occur within a first time period. Later, the process is repeated to determine the median sale price for sales transactions occurring within a second time period. The percentage change in the median sales price from the first time period to the second time period is typically reported as evidence as to whether home values are increasing or decreasing, and at what percentage change.

For example, in a recent newspaper a data information company reported resale single family residences and condos as well as new home percent change from the same month last year.

| Community | Zip | Median | % Chg | Sales | % Chg |
|---|---|---|---|---|---|
| All homes | | $485,000 | −23.6% | 2,266 | −15.3% |
| Total resale houses | | $537,000 | −22.7% | 1,522 | −9.6% |
| Total condominiums | | $353,750 | −23.1% | 573 | −11.8% |
| Total new homes | | $468,000 | −27.6% | 171 | −50.0% |
| Aliso Viejo | 92656 | $445,000 | −16.0% | 72 | −11.1% |
| Anaheim | 92801 | $360,000 | −34.5% | 22 | −4.3% |
| Anaheim | 92802 | $396,500 | −26.0% | 9 | −40.0% |
| Anaheim | 92804 | $392,500 | −28.2% | 49 | 88.5% |
| Anaheim | 92805 | $336,500 | −38.8% | 22 | −12.0% |
| Anaheim | 92806 | $424,000 | −30.2% | 10 | −9.1% |
| Anaheim | 92807 | $520,000 | −20.0% | 34 | −33.3% |
| Anaheim | 92808 | $560,000 | −11.8% | 30 | −9.1% |
| Brea | 92821 | $447,500 | −22.8% | 26 | −7.1% |
| Brea | 92823 | $517,000 | −29.4% | 3 | −25.0% |
| Buena Park | 90620 | $400,000 | −28.6% | 39 | 21.9% |
| Buena Park | 90621 | $400,000 | −27.6% | 25 | 31.6% |
| Corona del Mar | 92625 | $1,845,000 | 1.0% | 12 | −50.0% |
| Costa Mesa | 92626 | $525,000 | −21.6% | 26 | 8.3% |
| Costa Mesa | 92627 | $547,500 | −21.9% | 22 | −45.0% |
| Cypress | 90630 | $450,000 | −17.8% | 27 | −35.7% |
| Dana Point | 92624 | $239,000 | −58.1% | 3 | −57.1% |
| Dana Point | 92629 | $725,000 | −25.6% | 27 | −20.6% |
| Foothill Ranch | 92610 | $502,000 | −37.3% | 9 | 80.0% |
| Fountain Valley | 92708 | $615,000 | −6.8% | 38 | −2.6% |
| Fullerton | 92831 | $485,000 | −14.9% | 19 | −40.6% |
| Fullerton | 92832 | $500,000 | −10.7% | 9 | −30.8% |
| Fullerton | 92833 | $609,000 | −13.3% | 34 | 0.0% |
| Fullerton | 92835 | $675,000 | 11.4% | 27 | 35.0% |
| Garden Grove | 92840 | $380,000 | −29.6% | 33 | 0.0% |
| Garden Grove | 92841 | $405,000 | −27.8% | 18 | −5.3% |
| Garden Grove | 92843 | $385,000 | −25.1% | 21 | 31.3% |
| Garden Grove | 92844 | $417,500 | −11.1% | 14 | 0.0% |
| Garden Grove | 92845 | $480,000 | −19.9% | 12 | −29.4% |
| Huntington Beach | 92646 | $534,000 | −3.3% | 47 | 14.6% |
| Huntington Beach | 92647 | $570,000 | −10.2% | 34 | 3.0% |
| Huntington Beach | 92648 | $762,500 | −10.5% | 44 | 0.0% |
| Huntington Beach | 92649 | $636,500 | −4.7% | 26 | −29.7% |
| Irvine | 92602 | $605,000 | −16.5% | 29 | −14.7% |
| Irvine | 92603 | $815,000 | 16.0% | 28 | −12.5% |
| Irvine | 92604 | $525,000 | −21.6% | 21 | −34.4% |
| Irvine | 92606 | $662,500 | −9.4% | 14 | −6.7% |
| Irvine | 92612 | $506,250 | −24.2% | 19 | −64.2% |
| Irvine | 92614 | $532,000 | 6.6% | 22 | 37.5% |
| Irvine | 92618 | $496,000 | −15.2% | 6 | −71.4% |
| Irvine | 92620 | $725,000 | 36.8% | 31 | −26.2% |
| Ladera Ranch | 92694 | $662,500 | −1.9% | 35 | −38.6% |
| La Habra | 90631 | $360,000 | −35.7% | 45 | −15.1% |
| La Palma | 90623 | $553,750 | −13.5% | 10 | −9.1% |
| Laguna Beach | 92651 | $1,550,000 | 13.8% | 19 | −53.7% |
| Laguna Hills | 92653 | $346,250 | −52.6% | 32 | −3.0% |
| Laguna Niguel | 92677 | $645,000 | −15.0% | 88 | 7.3% |
| Laguna Woods | 92637 | $227,500 | −28.5% | 20 | −45.9% |
| Lake Forest | 92630 | $417,500 | −36.7% | 48 | −2.0% |
| Los Alamitos | 90720 | $830,000 | 17.5% | 14 | −30.0% |
| Midway City | 92655 | $365,000 | −32.2% | 1 | −83.3% |
| Mission Viejo | 92691 | $475,000 | −25.8% | 39 | 5.4% |
| Mission Viejo | 92692 | $521,500 | −17.9% | 55 | −16.7% |
| Newport Beach | 92660 | $1,500,000 | 7.7% | 22 | −47.6% |
| Newport Beach | 92661 | $1,460,000 | −35.0% | 2 | −60.0% |
| Newport Beach | 92662 | $2,400,000 | #N/A | 1 | 0.0% |
| Newport Beach | 92663 | $795,000 | −38.0% | 19 | −26.9% |
| Newport Coast | 92657 | $1,911,250 | −2.0% | 10 | −50.0% |
| Orange | 92865 | $545,000 | −18.7% | 27 | −22.9% |
| Orange | 92866 | $470,000 | −23.1% | 3 | −57.1% |
| Orange | 92867 | $505,000 | −20.4% | 33 | 17.9% |
| Orange | 92868 | $337,500 | −27.0% | 14 | −22.2% |
| Orange | 92869 | $530,000 | 7.1% | 32 | −28.9% |
| Placentia | 92870 | $475,500 | −12.4% | 40 | 5.3% |
| Rancho Santa | 92688 | $430,000 | −24.9% | 59 | −3.3% |
| Margarita | | | | | |
| San Clemente | 92672 | $730,000 | −23.8% | 33 | 26.9% |
| San Clemente | 92673 | $788,886 | −10.0% | 34 | −24.4% |
| San Juan Capistrano | 92675 | $310,000 | −60.4% | 30 | −23.1% |
| Santa Ana | 92701 | $272,500 | −29.9% | 15 | −34.8% |
| Santa Ana | 92703 | $307,000 | −39.8% | 25 | 19.0% |
| Santa Ana | 92704 | $337,500 | −39.2% | 51 | 50.0% |
| Santa Ana | 92705 | $614,000 | −34.0% | 30 | 15.4% |
| Santa Ana | 92706 | $445,000 | −27.0% | 12 | −20.0% |
| Santa Ana | 92707 | $267,500 | −51.4% | 30 | 57.9% |
| Seal Beach | 90740 | $659,000 | −19.6% | 10 | −9.1% |
| Stanton | 90680 | $328,000 | −18.2% | 23 | 27.8% |
| Trabuco/Coto | 92679 | $745,000 | −26.6% | 29 | −37.0% |
| Tustin | 92780 | $372,000 | −29.5% | 38 | 72.7% |
| Tustin | 92782 | $670,000 | −17.0% | 38 | −46.5% |
| Villa Park | 92861 | $1,200,000 | −8.4% | 9 | 80.0% |
| Westminster | 92683 | $448,500 | −22.0% | 41 | 36.7% |
| Yorba Linda | 92886 | $675,500 | −17.6% | 43 | −27.1% |
| Yorba Linda | 92887 | $315,000 | −63.5% | 10 | −54.5% |

As noted in the chart above, there are several markets where the number of sales was less than 10. An analysis based on 10 or fewer observations about a housing market in a zip code does not provide a statistically significant result. Also, even if more sales data was attained, one would not know if the mix of condo-sales to single family sales is constant on a period-to-period basis. For example, in the data mentioned above 573 of the 2,266 sales transactions were condominium sales making condominiums 25% of the units sold. If the “mix” of transactions changed for the subsequent time period so that 40% of the transactions were condominium sales that inherently had a less expensive transaction amount than single family homes, then the median sales price for the population may decline even though both single family housing sale prices and condominium sales price rose modestly. Thus, the composition or “mix” of the population of the residences being sold is one of the flaws with the median value technique.

However, these conventional systems use median selling prices, despite all of their limitations, because it is the accepted, traditional approach of providing an analysis that is easy to understand, readily available, and can be provided at the end of the month.

A second method is used to produce an index of home price appreciation. An example of a practitioner of this second method has been the firm of Case, Shiller and Weiss. This approach to measuring home price appreciation/depreciation involves determining an implied appreciation or depreciation of the same home selling over time. To build the index, one tracks the sale and subsequent sale of a particular property to determine two transactions known as a “matched-pair.” If there are enough of these repeat sales observations, then it is possible to “manufacture” an index of home price appreciation by performing a regression analysis to determine a best fit line quantifying the change shown in the matched pairs.

This approach suffers from the same disadvantage as the median value technique because price indices are reliant upon having enough matched-pair observations from which to make a statistically reliable index. Statisticians suggest that an index needs a minimum of 20 to 30 underlying observations to have a statistically reliable database. Often times, this quantity of matched-pair properties is not achievable for smaller sets of geography like zip codes or price tiers within zip codes.

Even within the industry that creates home price indexes there is confusion caused by geographic coverage and the source of the underlying data. In the Jul. 7^{th} 2008 issue, Business Week asks the question, “How much have home prices fallen from peak?” OFHEO (Organization of Federal Housing Enterprise Oversight) indices say 4.7% and Case Shiller Weiss (S&P/Case-Shiller Index) says %17.8. As is evident from the above article, there is great disparity between the various real estate indicators. Moreover, these real estate indicators all possess the same limitations, that is, these real estate indicators rely on “actual home sale prices” in arriving at their respective estimations.

Another limitation is that areas, e.g. city, neighborhood, that do not have enough “actual home sales” cannot be properly analyzed because a minimum amount of data points are needed to produce a home price index or a real estate trend.

Another limitation of this method based on housing sales is that the houses that are more likely to be sold repeatedly (“high turnover houses”) may be overstated in the population of transactions used to determine housing prices. Criticism about inaccuracy is focused on the concept that high turnover housing should not be used to value the rest of the housing stock because these houses are less desirable than the houses which the owners hang onto longer because they are more desirable.

Another limitation is that the population of houses analyzed using conventional methods may include only a subset of the total housing stock. For example, the population may merely include those that are financed with Fannie Mae or Freddie Mac conforming loans (ex: OFHEO price index). This biases the valuations of the rest of the housing stock which uses other financing methods (cash sales or others) which are not represented.

### SUMMARY OF THE INVENTION

The present invention overcomes the above-identified and other drawbacks and deficiencies of the aforementioned by providing a method, system, and computer program product that is able to more accurately provide a pricing trend to improve current lending practices.

Moreover, the present invention provides a real estate market trend indicator that obtains property data for each available property within a geographic area, such as the entire United States. The system sends the data to an automated valuation model (AVM) to calculate an estimated valuation for each real property within the geographic area. Separately, the System optionally conducts blind testing of the AVM to assess the AVM's accuracy in making the estimates. The System provides a valuation for each of the available properties within the geographic area and stores the individual valuations. By storing the valuations, the System accumulates a time-based history of the estimated valuations for each property within the geographic area. Using the stored estimated valuations, the System computes indicators for various trend analyses of the real estate property market for the geographic area. Furthermore, the present invention is able to distinguish and separate the data so that single family home data is separate from condo data, and a separate indicator is provided for each type of home.

One advantage, amongst others, of the present invention is an ability to analyze a property values on a national level on a daily, weekly, monthly or as needed basis or any other desired time increment. Also, the present inventors recognized that by retaining past estimated assessed values for each given property, the System is able to provide highly accurate time-based trending analysis results for properties in geographic footprints ranging from the national level to the 9-digit zip code level, if desired. This combination of (1) retained past AVM estimated values for particular properties, with (2) property data for all properties in the US and (3) a trending analysis engine provides a unique ability to produce highly accurate trending data that is based on assessed values for all the properties in the query area, where each estimated assessed data for each property is time-consistent. Moreover, by retaining past assessment estimates that were determined on a periodic basis, the underlying data on which the trending analysis is based are normalized to a common time frame. In contrast, conventional systems that do not retain past assessment estimates rely on data for one property that will necessarily be time-inconsistent (i.e., some estimates will certainly be more stale than others because they were updated at different times, based on transactions that occurred for respective properties).

Another advantage, amongst others, of the present invention is that it is able to calculate valuation for real estate on a national level and calculate various types of real estate indicators which show real estate market trends using time-consistent underlying data.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 is a schematic showing the system for predicting real estate market trends.

FIG. 2 is a flow chart showing an exemplary embodiment which produces a report which real estate indicator showing trends for a geographic area.

FIG. 3 illustrates an embodiment of a wide area network (WAN) and a local are network (LAN).

FIG. 4 illustrates an embodiment of computer system that may be suitable for implementing various embodiments of a system and method for parcel data acquisition and tracking.

FIG. 5 illustrates a portion of a report showing both the real estate trend indicator, e.g. true value trend, and a home price index.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling with the spirit and scope of the present invention as defined by the claims. The headings are for organizational purposes only and are not meant to be used to limit or interpret the description of the claims. Furthermore, it should be noted that the word “may” is used through out this application in a permissive sense (i.e., having the potential to, being able to,) not a mandatory sense (i.e., must).

### DETAILED DESCRIPTION OF PREFERRED EMBODIMENTS

Referring now to the drawings wherein like reference numerals designate corresponding parts throughout the several views. The present invention relates to a method and system used in calculating or predicting real estate market trends and various types of home price indices and remedies the deficiencies in previous related inventions.

The term “computer system” as used herein generally refers to the hardware and software components that in combination allow the execution of computer programs. The computer programs may be stored in software, hardware, or a combination thereof. A computer system's hardware generally includes a processor, memory media, and input/output devices. As used herein, the term “processor” generally describes the logic circuitry that responds to and processes the basic instructions that operate a computer system (e.g. a central processing unit). The term “memory” includes an installation medium, such as a CD-ROM; a volatile computer system memory such as DRAM, SRAM, RAM; or a non-volatile memory such as optical storage or a magnetic medium, e.g. a hard drive.

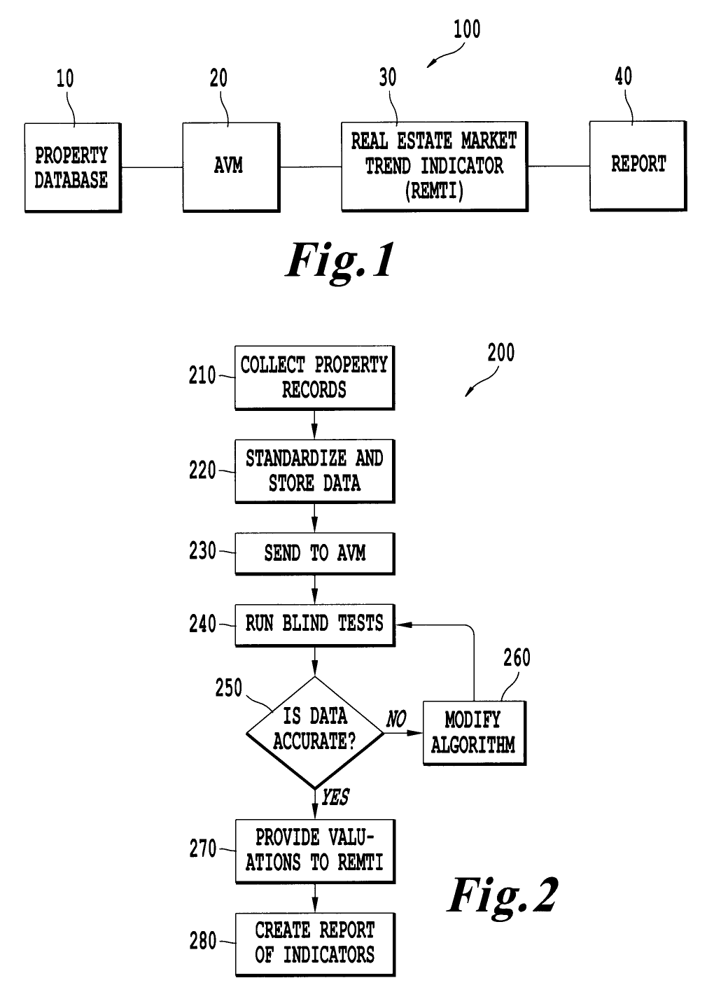

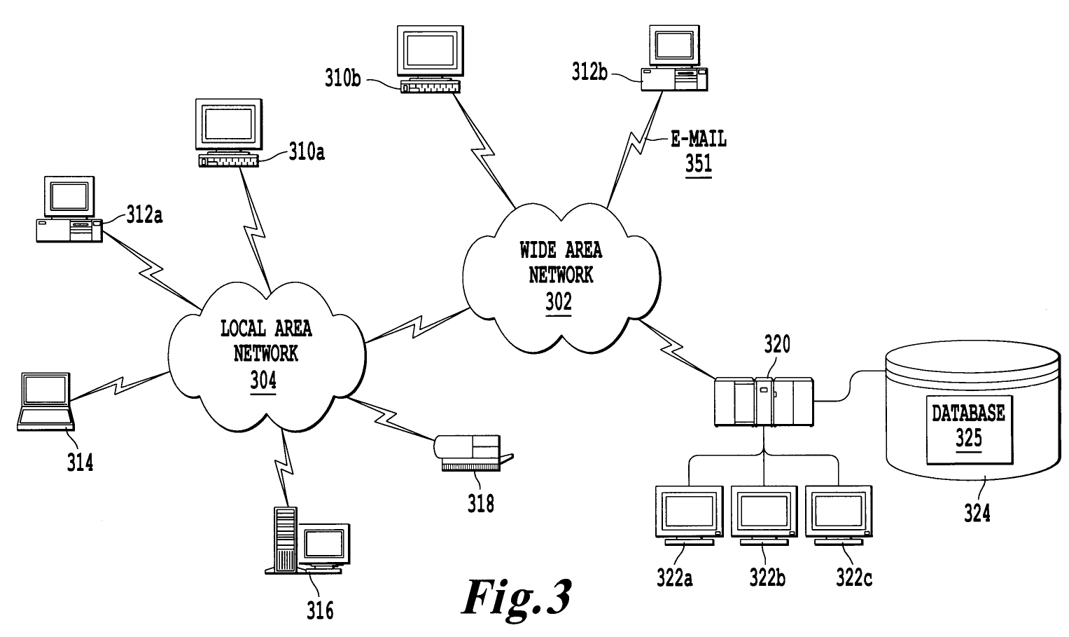

FIG. 3 illustrates an embodiment of a WAN 302 and a LAN 304. WAN 302 may be a network that spans a relatively large geographical area. The internet is an example of a WAN 302. WAN 302 typically include a plurality of computer systems that may be interconnected through one or more networks. Although one particular configuration is shown in FIG. 1, WAN 102 may include a variety of heterogeneous computer systems and networks that may be interconnected in a variety of ways and that may run a variety of software applications.

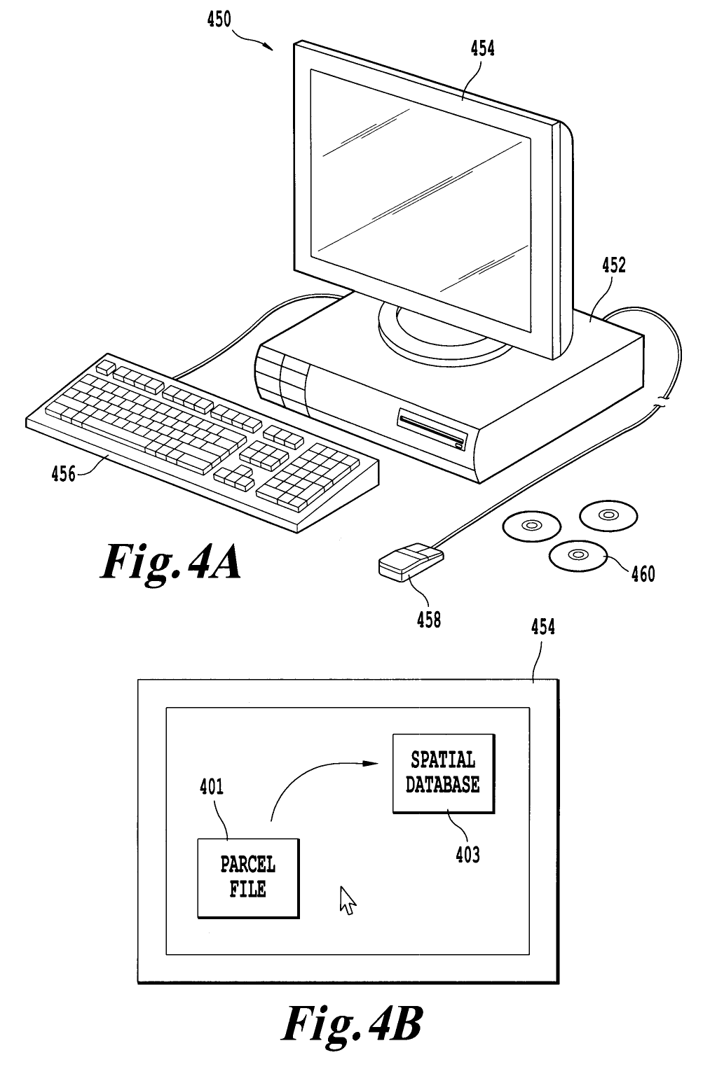

Each LAN 104 may include a plurality of interconnected computer systems and optionally one or more other devices. For example, LAN 304 may include one or more devices. For example, LAN 204 may include one or more workstations 310a, one or more personal computers 312a, one or more laptop or notebook computer systems 314, one or more server computer systems 316, and one or more network printers 318. As illustrated in FIG. 1, an example LAN 304 may include one of each computer system 310a, 312a, 314a and 316a and one printer 318. LAN 304 may be coupled to other computer systems and/or other devices and/or other LANs through WAN 102. FIGS. 4a and 4b illustrates an embodiment of computer system 250 that may be suitable for implementing various embodiments of a system and method for creating a system which is able to provide accurate pricing indicators of real estate. Each computer system 450 typically includes components such as CPU 452 with an associated memory medium such as Compact Disc Read-Only Memories (CD-ROMS) 260. The memory medium may store program instruction for computer programs. The program instructions may be executable by CPU 452. Computer system 450 may further include a display device such as monitor 454, an alphanumeric input device such as keyboard 456, and a directional input device such as mouse 258. Computer system 450 may be operable to execute the computer programs to implement computer-implemented systems and methods for continuously acquiring valuations and computing real estate pricing indicators.

Computer system 450 may include a memory medium on which computer programs according to various embodiments may be stored. The term “memory medium” is intended to include an installation medium, e.g., floppy disks or CD-ROMs 260, a computer system memory such as Dynamic Random Access Memory (DRAM), Static Random Access Memory (SRAM), Extended Data Out Random Access memory such as a magnetic media, e.g. a hard drive or optical storage. The memory medium may also include other types of memory or combination thereof. In addition, the memory medium may be located in a first computer, which executes the programs or may be located in a second computer, which connects to the first computer over a network. In the latter instance, the second computer may provide the program instructions to the first computer for execution. Computer system 450 may take various forms such as a personal computer system, mainframe computer system, workstation, network appliance, Internet appliance, personal digital assistant (PDA), television system or other device. In general, the term “computer system” may refer to any device having a processor that executes instructions from a memory medium.

The memory medium may store software program or programs operable to implement a method for computing and storing the valuations and then computing various type of real estate pricing index indicator and a system which is able to continuously generate valuations of nationwide database of real estate properties. The software program(s) may be implement in various ways, including, but not limited to, procedure-based techniques, component-based techniques, and/or object-oriented, amongst others. For example, the software programs may be implemented using ActiveX controls, C++ objects, JavaBeans, Microsoft Foundation Classes (MFC), browser-based applications (e.g., Java applets), traditional programs, or other technologies or methodologies, as desired. A CPU such as host CPU 252 executing code and data from the memory medium may include a means for creating and executing the software program or programs according to the embodiments described herein.

Various embodiments may also include receiving or storing instruction and/or data implemented in accordance with the foregoing description upon a carrier medium. Suitable carrier media may include storage media or memory media such as magnetic or optical media, e.g., disk or CD-ROM, as well as signals such as electrical, electromagnetic, or digital signals, may be conveyed via a communication medium such as a network and/or a wireless link.

As shown in FIG. 1, the present invention provides a system, i.e. a computer system, which provides real estate market trends or real estate indices. Various types of property information are collected on a daily, weekly, monthly or any time increment as may be desired by the user. The Property Database 10 may be used to standardize and store the data, so the data may be in a searchable format. Property information may include, but is not limited to, such information as: home sales price, number of bedrooms, square footage of property, location to a railroad or a water, property tax, designation of whether it is a home or a condo, address of property, local property information and in other information which might be useful in calculating real property valuations. In the exemplary embodiment, the present invention would use various real property databases of various companies like First American CoreLogic, First American Real Estate Services, LLC and other subsidiaries of The First American Corporation. These companies continuously obtain real property data either in real-time or near real-time and standardize the data so that the data can easily be assessed, searched and gathered so that the data may be used to calculate real property valuations. It should be appreciated that only a few companies have the capability to obtain property information on a majority of the properties in the U.S. In fact, First American CoreLogic recently has the technology and data to provide real property information on over 3100 counties in the United States.

It should be appreciated that conventional estimation systems mix the number of condo sales and single family sales in arriving at a real estate market trend indictor, e.g. mean housing prices, median housing prices, home price index. This mixture causes the real estate market trend indicator/home price indices to be distorted. For example, if we assume that condos that are typically less expensive than single family homes, then to get a true indication of value trends you must hold the mix of condos to single family homes constant in your median values. The property database 10 of the system 100 distinguishes whether a property may be a condo or a single family home

The system 100 also includes an automated valuation model (AVM) 20 based on a processor to provide valuations of each of the properties in a local. In the preferred embodiment the AVM may be a First American CoreLogic AVM called PASSPROSPECTOR. However, it should be appreciated that other known AVMs may also be used. AVM may be the name given to a processor that determines property valuations using mathematical modeling combined with a database. The AVM may calculate a property's value at a specific point in time by analyzing values of comparable properties. Data used in the analysis includes: surveyor valuations, historical house price movements and user inputs (i.e. number of bedrooms, home improvement spending, etc). An AVM may produce a residential Valuation Report in no more than seconds. The product of an automated valuation technology analysis, public record data, and computer decision logic combine to provide a logical calculated estimate of a probable selling price of a residential property. An AVM generally uses a combination of two types of evaluation, the running of a hedonic model and a repeat sales index. The results of each are weighed, analyzed and then reported as a final estimate of value based on a requested reasoning date.

The System and AVM 20 are able to test the accuracy of the valuations by running “blind testing”. Blind testing requires the AVM to calculate current values without knowledge of the most recent sale price. It may be accomplished by accessing recent sales information, from a provider of real estate information, e.g. First American CORELOGIC, and comparing it to AVM values which were valued at that specific time. The difference between the AVM calculated value for a house and its actual sales value is an error variable. The statistical distribution of the error variable is taken to be a normal (Gaussian) distribution with a mean of zero. The algorithms used by the AVM 20 are modified so that the mean value of the error is reduced to zero to ensure data accuracy 250. It is important to note that Uniform Standards of Professional Appraisal Practice (USPAP) guidelines prohibit appraisers from engaging in appraisals of pending sales without knowledge of the proposed sales price. Consequently, appraisers cannot perform a blind test the way that an AVM can. Furthermore, running “blind testing” allows the AVM to check the accuracy of its valuations. Blind testing may be done at a set frequency, for example: daily, weekly, monthly, etc. This testing prevents the propagation of errors from one time period to a later time period.

The present invention may also store all the AVM valuations and sales prices to build a database of housing data which continuously may be analyzed to: (1) ensure the AVM or AVMs are accurate through blind testing; and (2) if the valuations being calculated are not as accurate as desired to either manually or automatically modify the algorithm accordingly. This process creates a unique system which is transforming raw data into useful information which may more accurately assess housing prices, housing indices and various types of real estate trends indicators.

The valuations which are produced by the AVM 20 are then sent to the Real Estate Market Trend Indicator (REMTI) 30 in order to create accurate indicators, e.g. median home price, home price index. The system 100 may be continuously obtaining real estate property data and calculating AVM valuations on each available property in the desired geographic area. For example, the geographic area may be a neighborhood, city, state or nationwide. Also, the estimate updating procedure may be a round robin approach (first one, then a next, and continuing without stopping even after the returning to the first one), or a periodic update, where all estimates are made on a daily or weekly basis, for example. Importantly, when an estimate for a particular property is updated, the previous estimate is retained in memory and remains associated with that particular property. Thus, when retrieving an estimated valuation for a particular property, it is also possible to view all past estimated valuations for the property. When stored this way, it is possible to match time-consistent (i.e., about a same time) past valuation estimates for properties within the query. As a consequence, accurate trending may be performed because one data point for one property will be of the same era as a corresponding data point for another property in the analysis.

In an exemplary embodiment, the present invention may be able to take all of the real property valuations which are calculated on the nationwide database and provide various type of real estate indicators or indicators which show markets trends. The system takes all of the valuations created by the system and transforms that data into various types of real estate indicators which suggest or evidence various real estate trends. For example, a mean value can be obtained by taking the valuations obtained by the REMTI 30 and using the formula:

Mean=sum of elements/number of elements=(a1+a2+a3+ . . . +an)/n.

In another example, the REMTI may be able to calculate the nationwide arithmetic median value of real properties (able to separate in various categories, e.g. single family home vs. condo) nationwide. Arithmetic Median value is generally found by arranging the values in order and then selecting the one in the middle. If the total number of values in the sample is even, then the median is the mean of the two middle numbers. The arithmetic median is a useful number in cases where the distribution has very large extreme values which would otherwise skew the data. It should be appreciated that the transformed data along with the unique system is able to be used with various known indices, e.g. Case Shiller housing index, to produce more useful, accurate and distinguishing results.

Referring to FIG. 2, a flow chart shows an exemplary embodiment 200 which produces a report including various real estate indicators showing trends for a geographic area. The method begins by 210 collecting all the necessary property data in a geographic area. The geographic area may include any boundary or area (e.g. neighborhood, city, county) as may be desired by user. Examples may include residences located within a 9-digit zip code, a census track (a set geography having certain socio-demographic characteristics), County, town, or vanity geography (a geography that spans multiple zip codes, for example: Silicon Valley). The depth of data stored within the database may enable both macromarket valuation changes useful for financial entities (such as hedge funds) to value the residential housing values as an asset class at the national geography level or at the micromarket level for local valuation purposes such as for a single residence. The data may be then standardized and stored at 220 in the property database 100. This allows the data to be easily searchable, so that the necessary data may be provided to the AVM. The data may be then sent to the AVM 230 wherein the AVM calculates valuations for each available property in the given geographic area. At 240, the AVM runs blind testing to ensure the data is accurate. If the valuations are found not to be accurate, i.e. they are outside of an acceptable range of error (e.g. off by more than 10% of actual home price sale), then the AVM may be either manually modified or automatically modified (e.g. using smart or fuzzy logic to modify its algorithm) to provide valuations within an acceptable range of error. Once the valuations are determined to be acceptable the data may be provided to the REMTI at step 270. The REMTI 30 then uses the data to calculate the various indicators for analyzing various geographical real estate market trends and prepares a report at step 40.

A method step for the AVM 20 may be to use a technique called “trending.” This technique requires the storage of previous valuation data calculated by the AVM 20 for previous time periods. The previous valuations are considered a proxy for the valuation of residential property. The advantage of having the previous valuations used as a proxy is that when they are calculated using a consistent methodology, then the error may be systematically removed via modification of the algorithms. One example of trending, as produced by a trending engine (a software based process in this embodiment), a rate of change of property values for all properties within a particular geographic footprint (e.g., a particular zip code, or voting district), for a predetermined period of time (e.g., 5 years).

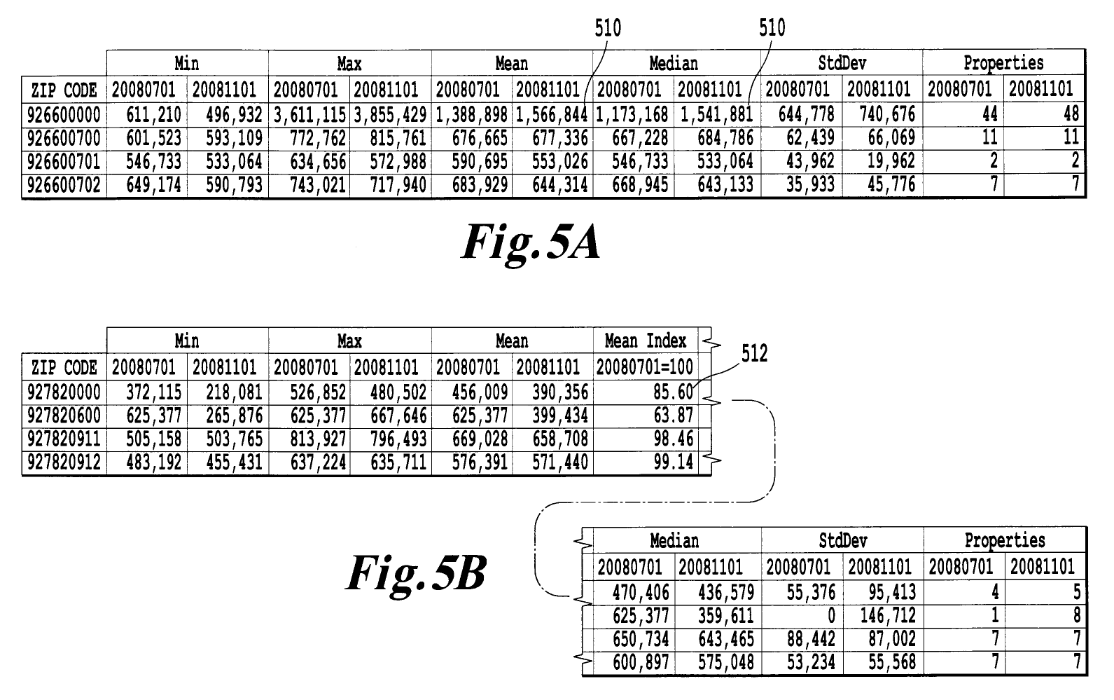

FIGS. 5a and 5b illustrate a portion of a report showing both the real estate trend indicator 510, e.g. true value trend, and a home price index 512. FIG. 5a illustrates various mean, median and max prices based on valuations produced by the REMTI for single family homes in different 9 digit zip codes. FIG. 5b illustrates various mean median and max prices based on valuation produced by the REMTI for condos in various 9 digit zip codes. FIG. 5b provides the mean index 512 for each zip code. In an index you establish a base period as index=100. If the index goes down (below 100) then the trended variable has declined vs. the base period. In the exemplary embodiment show in FIG. 5b, the index in 92782-000 is 85.60. This means that the average home value in this 9 digit zip has declined by %14.4 (100-85.6). Indices are a way to insure that percentage change is calculated vs. the identical base number (or denominator).

As shown in exemplary embodiment in FIG. 5, median home prices for Single Family homes are shown in Tustin, Calif. which corresponds to zip code 92782. The present system may be able to analyze all the relevant data obtained for that geographical area and provide both the mean home price 510 and a home price index 512. It should be noted, that the present invention may be able to even go to a smaller geographic area in determining various real estate trend indicators and home price indices. Therefore, the present invention may be able to go to specific neighborhoods within Tustin, e.g. 92782-1106, 92782-1109, 92782-2111, and obtain valuations for each available property and provide a real estate trend indicator and/or home price index.

Although particular embodiments have been described in detail herein with reference to the accompanying drawings, it is to be understood that the invention may not be limited to those particular embodiments, and that various changes and modifications may be affected therein by one skilled in the art without departing from the scope or spirit of the invention as defined in the appended claims.

What is claimed is:

1. A method for providing a real estate market trend indicator, comprising:
obtaining property data for each available property within a geographic area;
sending the data to an AVM;
estimating in the AVM a valuation for each real property within the geographic area at a predetermined time;
saving in memory the valuation for each real property;
repeating said estimating and saving steps to produce a set of estimated valuations for each real property, each of said estimated valuations corresponding to a different time;
receiving a query for trending data for properties within the geographic area;
retrieving respective sets of estimated valuations for said properties within said geographic area; and
computing an indicator from said respective sets of estimated valuations to provide a trend analysis of a real estate property market for the geographic area.

2. The method of claim 1, further comprising:
conducting blind testing of the AVM to adjust an accuracy of the AVM.

3. The method of claim 1, wherein the indicator includes at least one of a mean housing price, a median housing price and a home price index.

4. The method of claim 1, wherein the geographic area is at least one of a city, county, state and nation.

5. The method of claim 1, wherein property valuations are conducted on at least one of a daily, weekly and monthly basis.

6. The method of claim 1, further comprising:
distinguishing property to indicate whether the property is a condominium or a single family home and computing a condominium indicator and a single family home indicator.

7. A computer readable medium having instructions for causing a computer to execute a method for providing a real estate market trend indicator, comprising:
obtaining property data for each available property within a geographic area;
sending the data to an AVM;
estimating in the AVM a valuation for each real property within the geographic area at a predetermined time;
saving in memory the valuation for each real property;
repeating said estimating and saving steps to produce a set of estimated valuations for each real property, each of said estimated valuations corresponding to a different time;
receiving a query for trending data for properties within the geographic area;
retrieving respective sets of estimated valuations for said properties within said geographic area; and
computing an indicator from said respective sets of estimated valuations to provide a trend analysis of a real estate property market for the geographic area.

8. The computer readable medium of claim 7, further comprising:
conducting blind testing of the AVM to adjust an accuracy of the AVM.

9. The computer readable medium of claim 7, wherein the indicator is selected from a group consisting of mean housing price, median housing price or home price index.

10. The computer readable medium of claim 7, wherein the geographic area is at least one of a city, county, state and nation.

11. The method of claim 7, wherein property valuations are conducted on at least one of a daily, weekly and monthly basis.

12. A real estate market indicator system, comprising:
a processor;
a memory coupled to the processor and configured to store program instructions executable by the processor to:
obtain property data for each available property within a geographic area;
send the data to an AVM;
estimate in the AVM a valuation for each real property within the geographic area at a predetermined time;
save in memory the valuation for each real property;
produce a set of estimated valuations for each real property, each of said estimated valuations corresponding to a different time;
receive a query for trending data for properties within the geographic area;
retrieve respective sets of estimated valuations for said properties within said geographic area; and
compute an indicator from said respective sets of estimated valuations to provide a trend analysis of a real estate property market for the geographic area.

13. The system according to claim 12 wherein the indicator is selected from at least one of a mean housing price, median housing price and home price index.

14. The system according to claim 12 wherein the geographic area is at least one of a city, county, state and nation.

15. The system according to claim 12, further including means for distinguishing which properties which are condominiums and single family homes and computing a condominium indicator and a single family home indicator.
